(19) United States
(12) Patent Application Publication
(10) Pub. No.: US 2019/0303753 A1
(43) Pub. Date: Oct. 3, 2019

(54) INSERTION TOLERANT LEARNED INDEX STRUCTURE THROUGH ASSOCIATED CACHES

(71) Applicant: CA, Inc., New York, NY (US)

(72) Inventor: Christopher Phillip Bonnell, Longmont, CO (US)

(21) Appl. No.: 15/938,048

(22) Filed: Mar. 28, 2018

(51) Int. Cl. G06N 3/08; G06F 17/30

(52) U.S. Cl. CPC G06N 3/08; G06F 17/3048; G06F 17/30342

(57) ABSTRACT

Traditional index structures can be replaced with machine learning models, such as deep-learning models or neural networks, to realize improvements in performance and memory efficiency. These machine learning models (referred to herein as “learned indexes”), however, require potentially time-consuming training or learning over a data set to be indexed. To avoid or delay time-consuming training, a cache is associated with models in the learned index to buffer insertions. When new data is received, a key for the new data is stored in a cache associated with a model or node of the learned index. If read requests for the new data are received, the data can still be found through searching the caches in the learned index for the corresponding key. This allows for retraining of the learned index to be delayed to a low-utilization period or until the caches associated with the learned index are full.

### BACKGROUND

The disclosure generally relates to the field of data processing, and more particularly to database and file management or data structures.

Indexes are data structures that allow for fast lookup and retrieval of data. Examples of index data structures include binary search trees, B−trees, B+ trees, hash-index, etc. Typically, indexes allow for quickly finding a data item in a database or other storage by using a key for the item. A key for an item is used to traverse an index from a root node to a leaf node which contains the item or a pointer to the item's location. For example, in a binary search tree, the key is compared to a number in the root node to determine which path to take from the root node. A subsequent child node is selected based on whether the key is greater than or less than the number in the root node and traversal of the tree continues based on comparisons to numbers in child nodes until a leaf node is reached. Some indexes have restrictions such as requiring keys to be in a sorted order, limits on tree height, etc.

Machine learning allows a computer system to “learn” with data and progressively improve performance for a specific task based on the data. An example of a machine learning framework is a neural network. Neural networks simulate the operation of the human brain to analyze a set of inputs and produce outputs. In conventional neural networks, neurons (also referred to as perceptrons) can be arranged in layers. Neurons in the first layer receive input data. Neurons in successive layers receive data from the neurons in the preceding layer. A final layer of neurons produces an output of the neural network. When a neuron receives input, it applies a set of learned coefficients to the input data to produce an output of the neuron. The coefficients of the neurons are learned through a process of training the neural network. A set of training data is passed through the network, and the resulting output is compared to a desired output. Error values can be calculated based on how different the resulting output is from the desired output. The error values can be used to adjust the coefficients. Repeated application of training data to the neural network can result in a trained neural network having a set of coefficients in the neurons such that the trained neural network can accurately classify data, recognize data, or make decisions about data in data sets that have not been previously seen by the neural network.

### BRIEF DESCRIPTION OF THE DRAWINGS

Aspects of the disclosure may be better understood by referencing the accompanying drawings.

FIG. 1 depicts an example learned index structure with model-associated caches for buffering insertions to delay retraining.

FIG. 2 depicts an example learned index structure experiencing a cache overflow that triggers retraining.

FIG. 3 depicts an example learned index structure after flushing insertions from the model-associated caches and retraining.

FIG. 4 depicts a flowchart with example operations for caching insertions for a learned index structure.

FIG. 5 depicts a flowchart with example operations for process read requests using a cache associated learned index structure.

FIG. 6 depicts an example computer system with a cache associated learned index interface.

### DESCRIPTION

The description that follows includes example systems, methods, techniques, and program flows that embody aspects of the disclosure. However, it is understood that this disclosure may be practiced without these specific details. For instance, this disclosure refers to index structures based on machine learning models in illustrative examples. Aspects of this disclosure can be also applied to machine learning models used for tasks other than indexing data, such as image recognition. In other instances, well-known instruction instances, protocols, structures and techniques have not been shown in detail in order not to obfuscate the description.

Overview

Traditional index structures can be replaced with machine learning models, such as deep-learning models or neural networks, to realize improvements in performance and memory efficiency. These machine learning models (referred to herein as “learned indexes”), however, require potentially time-consuming training or learning over a data set to be indexed in order to effectively function as an index data structure for data retrieval. Additionally, because machine learning models are used, changes to the indexed data set, such as insertions, can affect the learned index and require additional or new training. To avoid or delay time-consuming training, a cache is associated with models in the learned index to buffer insertions. When new data is received, a key for the new data is stored in a cache associated with a model or node of the learned index. If read requests for the new data are received, the data can be found through searching the caches in the learned index for the corresponding key. This allows for retraining of the learned index to be delayed to a low-utilization period or until the caches associated with the learned index are full.

Example Illustrations

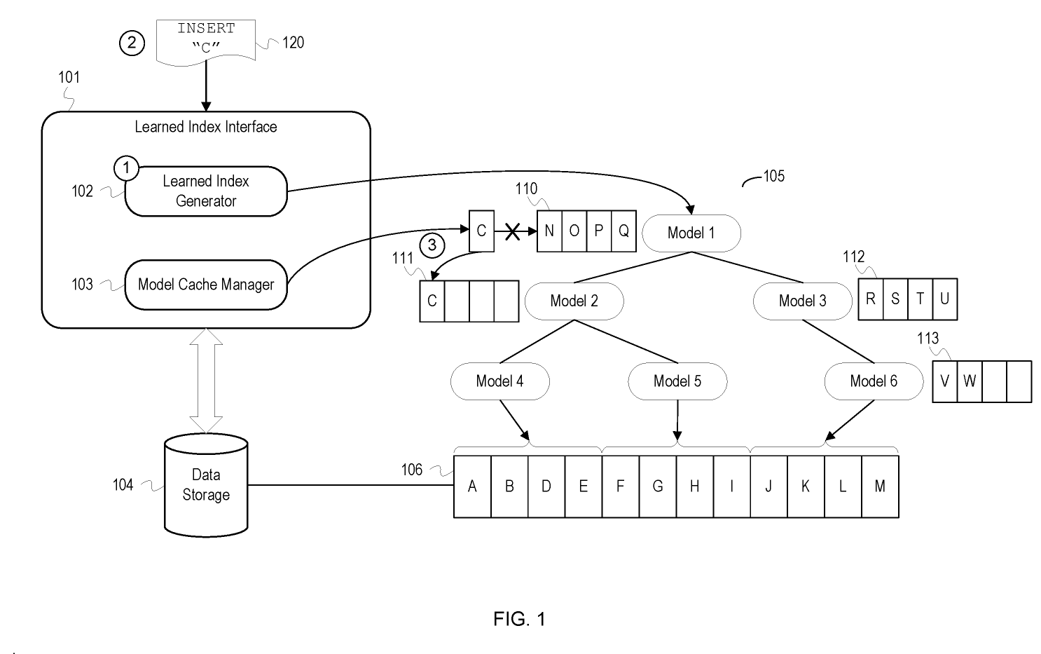

FIG. 1 depicts an example learned index structure with model-associated caches for buffering insertions to delay retraining. FIG. 1 depicts a learned index interface 101 (“interface 101” that includes a learned index generator 102 (“generator 102”) and a model cache manager 103 (“manager 103”). The learned index interface 101 is communicatively coupled to data storage 104. The data storage 104 contains an array 106.

At stage 1, the generator 102 creates a learned index structure 105 and trains models in the learned index structure 105 based on the data in the array 106. In FIG. 1, the letters in the array 106 and the learned index structure 105 represent keys which may be used to locate data such as a database record. For example, each key may be associated with a pointer to data corresponding to the key. The learned index structure 105 is a machine learning model which is trained to index the data in the array 106. For example, the learned index structure 105 may be a neural network whose structure is preconfigured or is determined based on a type or size of the data in the array 106. The generator 102 may be configured to create a learned index structure 105 with a specified number of input layer nodes, hidden layer nodes, and output layer nodes. In some instances, the number of nodes in each layer may be adaptively determined based on the size of the data set. In FIG. 1, the learned index structure 105 comprises six models with Model 1 serving as a root, input layer node; Models 2 and 3 serving as hidden layers; and Models 4-6 serving as leaf nodes or output layer nodes that point to ranges in the array 106.

At the time of stage 1, Models 1, 3, and 6, in the learned index structure 105 are already associated with caches 110, 112, and 113 and contain keys from previous insertions (Model 2 is later associated with a cache 111 as described at stage 3 below). The caches 110, 112, and 113 each contain keys which were received along with commands to insert the keys in the learned index structure 105. Even though the keys are cached and have not been inserted, the keys may be used to facilitate read requests. If a read request is received for the key V, for example, the learned index structure 105 is traversed from the Model 1 to the Model 3 to the Model 6. The range in the array 106 pointed to by the Model 6 is then searched for the key V. Since the key V is not in the array 106, this process returns a read miss. In response to the read miss, the interface 101 scans the caches associated with models which were activated during the traversal, i.e. were in the path of the traversal for the key V. A model (e.g., a node or neuron) is considered activated if the input of a key into the learned index structure 105 causes the model to receive data from a parent node or otherwise be invoked during traversal of the models. For example, based on the key V, the models 1, 3, and 6 would be activated or invoked when attempting to find the key V in the learned index structure 105. The interface 101 may begin by scanning caches associated with lower level models which were activated to determine whether they contain the key V. In this instance, the interface 101 reads the key V from the Model 4 cache 113 and uses a pointer associated with the key V to retrieve the corresponding data for satisfying the read request.

At stage 2, the interface 101 receives a command 120 to insert a key C into the array 106. The command 120 may be part of a write request to store data in the data storage 104. In response to storing the data in the data storage 104, a key and a pointer to the data are to be inserted into the learned index structure 105. In some implementations, the interface 101 may attempt to insert the key into an available space in the array 106 if the insertion would not cause retraining. The key may be inserted without requiring retraining if a range in the array 106 pointed to by a model includes an empty entry. In FIG. 1, however, the key C would be inserted between the keys B and D in the range of the array 106 pointed to by the Model 4. In this instance, there is not an available space or entry for inserting the key C, so inserting the key would require retraining of at least the Model 4 in the learned index structure 105. As a result, caching the key is a better solution since retraining can be avoided.

At stage 3, the manager 103 determines that the model 1 cache 110 is full and initializes a Model 2 cache 111 for storing the key C. Prior to allocating space for the Model 2 cache 111, the manager 103 determines a path through the learned index structure 105 which would lead to the key C. The manager 103 may query or invoke the model 1 of the learned index structure 105 with the key C to determine which model is subsequently activated based on the input, i.e. Model 2 or Model 3. For example, the Model 1 may behave like a binary search tree by comparing the key C to a key value associated with the Model 1 and determining a path through the learned index structure 105 based on the comparison. In FIG. 1, the Model 1 activates the link to the Model 2 based on the key C. As a result, the manager 103 determines whether the key C can be stored in a cache associated with the Model 2. Since Model 2 did not have an existing cache, the manager 103 allocates space for the Model 2 cache 111 and associates the Model 2 cache 111 with the Model 2. A cache can be associated with a model by storing an identifier for the model and a pointer to allocated memory space for the cache in a table in memory. For example, the identifier “Model 2” and a pointer to the memory location of the Model 2 cache 111 may be stored in an in-memory table. After allocating the cache 111, the manager 103 stores the key C in an entry of the Model 2 cache 111.

In some implementations, the key C may be stored in the Model 1 cache 110 and one of the entries in the Model 1 cache 110 may be pushed to a cache of a lower level model in the learned index structure 105. For example, the cache manager 103 may manage the cache entries in first in first out (FIFO) or last in first out (LIFO) manner. The FIFO manner would allow older entries to be pushed toward lower level caches, while the LIFO manner would push down newer entries. Whether FIFO or LIFO is selected may depend upon how the caches are scanned during a read operation. If lower level caches are scanned first after a read miss in the learned index structure 105, then it may be beneficial to push down newer entries since newer data is generally more likely to be accessed. Conversely, a FIFO cache management may be preferred if keeping newer entries in the root node is desired.

Although depicted as a tree structure in FIG. 1, the learned index structure 105 is not necessarily a tree structure and may more resemble a graph or network structure. A child model may be pointed to by multiple parent models. For example, the Model 5 may be linked to by both the Model 2 and the Model 3. Additionally, leaf models may point to overlapping ranges in the array 106. As a result, unlike a tree structure, the learned index structure 105 may contain multiple potential paths for determining the location of desired data. As a result, the model cache manager 103 may put data to be inserted in multiple model caches. For example, if the Model 4 and Model 5 structures would both potentially point to the key C's location, the model cache manager 103 may insert the key C in a cache for both Models 4 and 5 if the key C is ever pushed from the Model 2 cache to the lower level in the learned index structure 105.

Although the caches 110, 111, 112, and 113 are depicted as being separate, the caches may be managed as a single array or contiguous space allocated from memory. The caches may be referenced using pointers to the start of each cache, an array index for each cache, or using offsets from a pointer to the beginning of the allocated space to each cache. As additional caches are allocated or initialized, the new cache may be appended to the end of the existing array or allocated space.

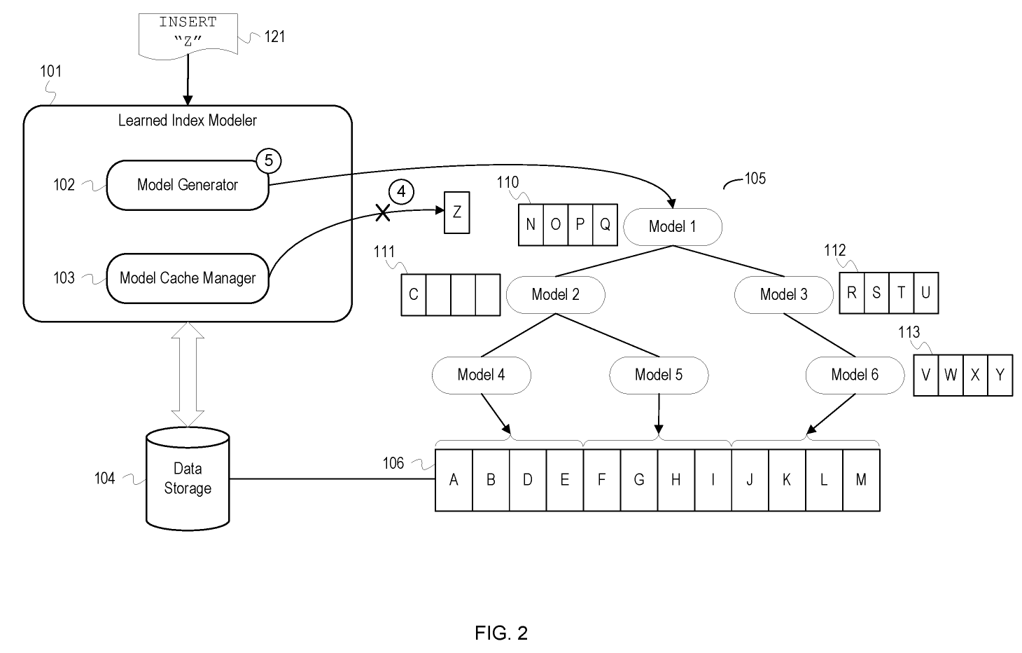

FIG. 2 depicts an example learned index structure experiencing a cache overflow that triggers retraining. FIG. 2 continues from the stages described in FIG. 1 and, therefore, depicts similar elements to those depicted in FIG. 1.

At stage 4, the manager 103 responds to an insert command 121 by attempting to store the key Z in a cache associated with a model in the learned index structure 105. The manager 103 first determines whether the key Z can be stored in the Model 1 cache 110. Since the Model 1 cache 110 is full, the manager 103 traverses the learned index structure 105 to the next model which would be activated based on the key Z which is the Model 3. Since the Model 3 cache 112 is also full, the manager 103 continues down a path for the key Z through the learned index structure 105 to the Model 6 cache 113. The manager 103 determines that the Model 6 cache 113 is also full and, thus, the key Z cannot be cached. Even though other cache entries are available in the learned index structure 105, the key Z should be stored in a cache associated with a traversal path of the key Z. As a result, the manager 103 determines that the cache has overflowed and that retraining of the learned index structure 105 is required. Alternatively, in some implementations, the manager 103 may increase the size of each cache if sufficient memory space is available instead of flushing the caches and performing retraining at stage 5. For example, the manager 103 may increase the size of each cache so that each cache can store an additional key. The manager 103 may continue increasing the cache size until sufficient memory space is no longer available or performance of the learned index structure 105 has degraded due to a size of the caches. For example, if performance of the learned index structure 105 is approaching O(n), the manager 103 may determine that retraining should be performed instead of increasing the cache size.

Prior to initiating retraining, the manager 103 flushes the keys from the cache entries and performs insertions for each of the keys. Inserting the keys can be performed by appending the keys to the array 106 and then sorting the array 106. After inserting the keys, the manager 103 may deallocate or free up space in memory previously occupied by the cache entries.

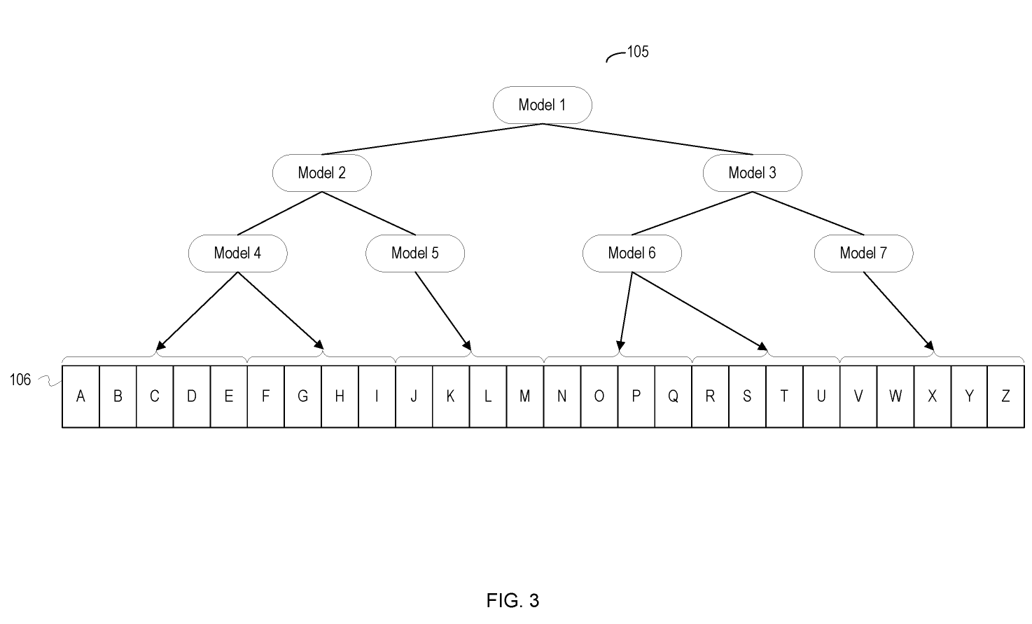

At stage 5, the generator 102 initiates retraining of the learned index structure 105 in response to the Model 4 cache 113 being full. The generator 102 performs the training after the cached keys have been inserted. As shown in more detail in FIG. 3, the generator 102 may also restructure the learned index structure 105 in response to the change in the amount of keys. For example, the generator 102 may add additional nodes or models to the learned index structure 105. During the retraining period, the interface 101 may contain another process which buffers or rejects requests during a retraining period. Alternatively, the interface 101 may still service requests, such as read requests, without use of the learned index structure 105 by linearly searching the array 106 and returning requested data.

In some implementations, a partial retraining of the learned index structure 105 may be possible. For example, the keys in the Model 6 cache 113 may be flushed from the cache and appended to the array 106. The generator 102 can then create a model as a child to the model 3 which points to the appended keys in the array 106. Since keys are merely appended, the keys and an additional model can be added without affecting or requiring retraining of the other models in the learned index structure 105.

FIG. 3 depicts an example learned index structure after flushing insertions from the model-associated caches and retraining. FIG. 3 depicts the learned index structure 105 and the array 106 after the operations of stages 4 and 5 have been performed. As shown in FIG. 3, the array 106 reflects the insertion of the keys which were flushed from the cache at stage 4. Additionally, as a result of the reconfiguration and retraining by the generator 102, the learned index structure 105 includes an additional model, Model 7, and the leaf models (Models 4-7) point to new ranges that accommodate the inserted keys.

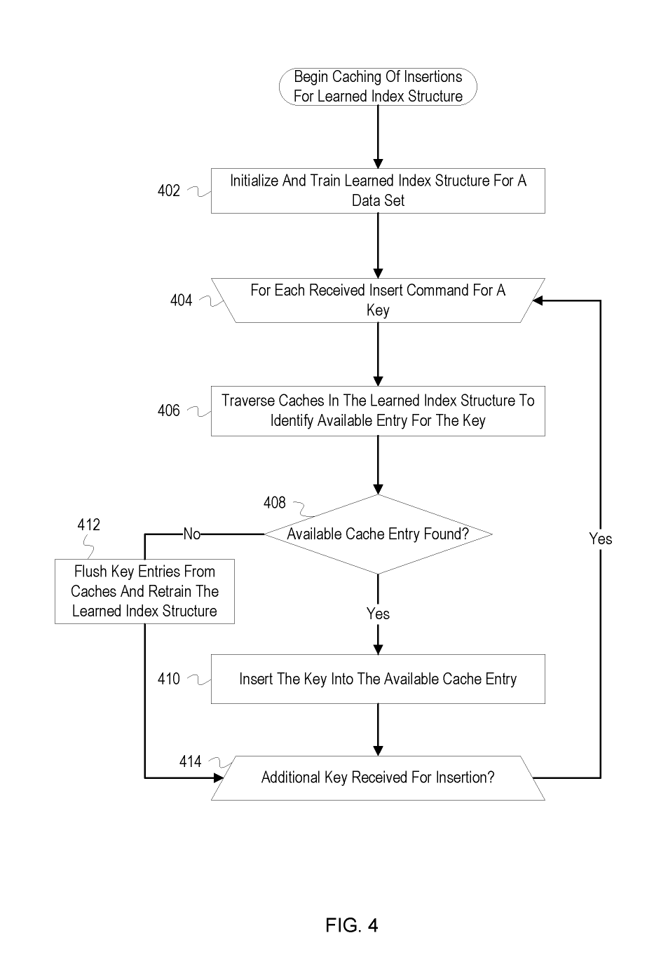

FIG. 4 depicts a flowchart with example operations for caching insertions for a learned index structure. FIG. 4 refers to a learned index interface as performing the operations for naming consistency with FIGS. 1-3, although naming of program code can vary among implementations.

A learned index interface (“interface”) initializes and trains a learned index structure for a data set (402). The interface may configure the learned index structure according to a predetermined configuration or may analyze a set of keys to be learned and determine a structure suitable to the number, sorting, and size of the keys. For example, the interface may initialize a neural network with a number of input, middle, and output layer nodes, wherein the number of nodes in each layer are proportional to a number of keys. The interface then trains the learned index structure. The interface may input a set of training data such as keys and compare the outputs of the learned index structure to known locations of the keys. After training the learned index structure, the interface may utilize the learned index structure to retrieve data in response to read requests.

The interface performs operations as commands to insert keys are received (404). The interface performs the below operations for each key to be inserted into the learned index structure. The insertion commands may be generated by another process of the interface in response to receiving write requests. The process may store data received with the write request and then pass an insertion command with a key and a pointer to the stored data to the interface.

The interface traverses caches in the learned index structure to identify an available entry for the key (406). The caches associated with models in the learned index structure may be maintained in a table in memory that maps identifiers for models and pointers to memory locations of the associated caches. The interface scans caches which are associated with models in a traversal path for the key for an available entry, i.e. if a model is not activated by the key, then the key cannot be stored in the model's associated cache. The interface may first determine whether a root node or input layer model of the learned index structure has an associated cache with an available entry. If the root model has a cache entry available, the interface can stop searching the caches since the key may be stored in a root node cache. If the root model does not have an available cache entry, the interface queries or inputs the key into the learned index structure to determine which models are activated in response to the key at a next layer of the learned index structure. The interface then determines whether any of the activated models have an associated cache with an available entry. The interface continues this process until a lowest layer of the learned index structure is reached. If any of the activated models do not have an existing cache, the interface allocates a cache for the model. The interface may allocate the cache by sending a request to allocate memory space and then adding a pointer to the allocated memory space into the table of caches for the learned index structure.

The interface determines whether an available cache entry was found (408). If the interface found a cache with an available entry or allocated a new cache for a model without an existing cache, the interface determines that the key can be cached. If the interface reached a lowest layer in the learned index structure without finding an available cache entry, the interface determines that the key cannot be cached.

If an available cache entry was found, the interface inserts the key into the available cache entry (410). The interface adds the key and a pointer for the corresponding data in the identified empty cache entry. In some implementations, insertion may involve moving a previously cached key to a lower level cache in the learned index structure depending upon a caching scheme used, such as LIFO or FIFO. Also, in some implementations, the interface may tag or associate each inserted key with a unique, sequential identifier. For example, a first key inserted into a cache may be tagged with a 1, and a second key tagged with a 2. The sequential identifiers allow for the insertions to be performed in the order in which they were received when a cache flush occurs.

If an available cache entry was not found, the interface flushes key entries from the caches and retrains the learned index structure (412). Since no available cache entry was found, the interface determines that the caches for at least one traversal path in the learned index structure are full and have overflowed. As a result, the interface begins flushing keys from the caches and inserting the keys into the data structure of the existing keys, such as an array, graph, tree, list, hash, map, etc. The interface then retrains the learned index structure based on the new keys. In some instances, the interface may modify the structure of the learned index structure in response to the increase in the number of keys.

After flushing the caches and retraining the learned index structure or after inserting a key into an available cache entry, the interface waits until an additional key is received for insertion (414). Once an additional key is received for insertion, the interface again performs the operations beginning at block 404.

The operations of the block 410 may be performed in response to triggers other than a cache overflow. For example, the cached keys may be flushed and inserted into the existing keys at scheduled times when retraining of the learned index structure is less likely to cause performance issues. Additionally, the interface may monitor a request load and perform flushing of the cache and retraining during periods of sustained low request load.

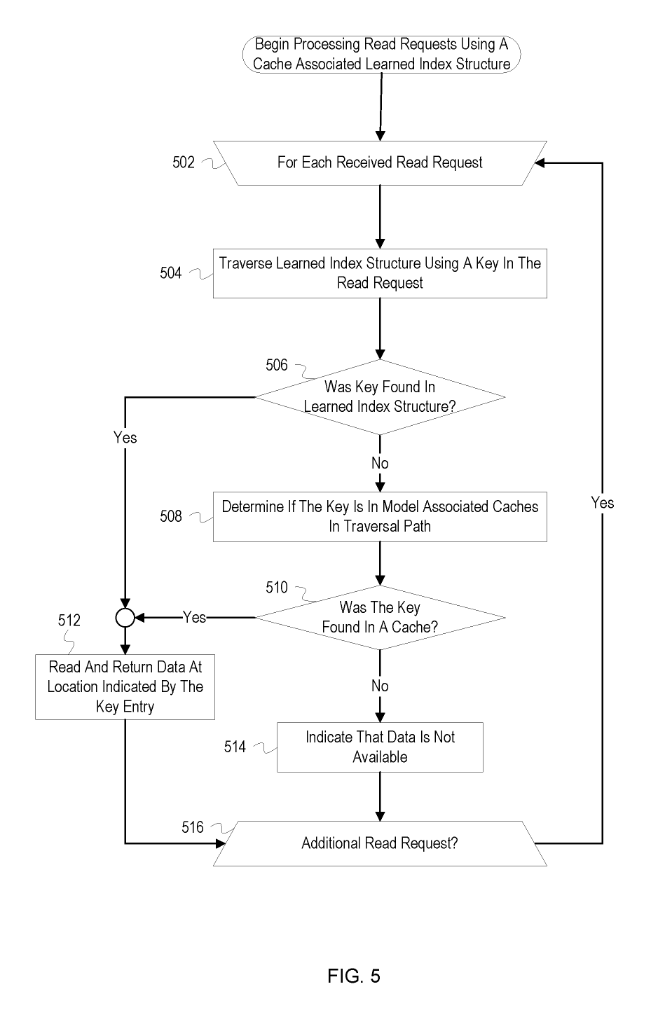

FIG. 5 depicts a flowchart with example operations for process read requests using a cache associated learned index structure. FIG. 5 refers to a learned index interface as performing the operations for naming consistency with FIGS. 1-3, although naming of program code can vary among implementations.

The learned index interface (“interface”) performs operations for each received read request (502). The interface performs the below operations each time a read request is received to facilitate data retrieval using a learned index structure.

The interface traverses the learned index structure using a key in the read request (504). The interface inputs the key into the learned index structure and receives an output. The output may be a pointer to a range of keys. The interface then searches the range to determine whether the range includes the key.

The interface determines whether the key was found in the learned index structure (506). If the key was found in a traversal of the learned index structure, the interface determines that the key was found. If the key was not found in a traversal of the learned index structure, the interface determines that a read miss occurred, i.e. that the key could not be found.

If the key was not found, the interface determines if the key is in caches associated with models in the traversal path (508). The key of the read request may have been previously stored in caches of the learned index structure in response to an insertion command. Keys are stored in caches associated with models which are in a traversal path of the keys. As a result, the interface does not need to search every cache associated with models of the learned index structure but may instead just search the caches associated with models which were activated in response to the traversal at block 504. The interface can identify locations of the caches in memory from a table or list of cache locations and compare keys stored in the caches to the key of the read request.

The interface determines if the key was found in a cache (510). If the key matched a cached key, the interface determines that an entry for the key exists and that a location of data corresponding to the key is available. As a result, the interface is able to perform the read request.

If the key was found in the learned index structure or was found in a cache, the interface reads and returns data at location indicated by the key entry (512). The interface retrieves a pointer associated with the key and reads data at the location indicated by the pointer. The interface then satisfies the read request by returning the data.

If the key was not found in a cache, the interface indicates that the data is not available (514). Since the key could not be found in the learned index structure or in caches associated with models of the learned index structure, the interface is unable to determine a location of data to satisfy the read request. As a result, the interface may transmit a command indicating that the read request failed.

After reading and returning data at a location indicated by the key entry or after indicating that the data is not available, the interface waits until an additional read request is received (516). Once another read request is received, the interface again performs the operations beginning at block 502.

Variations

FIGS. 1 and 2 are annotated with a series of numbers 1-5. These numbers represent stages of operations. Although these stages are ordered for this example, the stages illustrate one example to aid in understanding this disclosure and should not be used to limit the claims. Subject matter falling within the scope of the claims can vary with respect to the order and some of the operations.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 504 and 508 of FIG. 5 can be performed in parallel or concurrently. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

Although the description above focuses on insertions, other commands which would affect the structure or data of an index may be similarly buffered. For example, a delete command can be buffered if performing the delete would require retraining. Additionally, commands such as resorting the keys, moving the keys to a new location, etc., can be buffered and performed during a designated time for retraining of the learned index structure.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

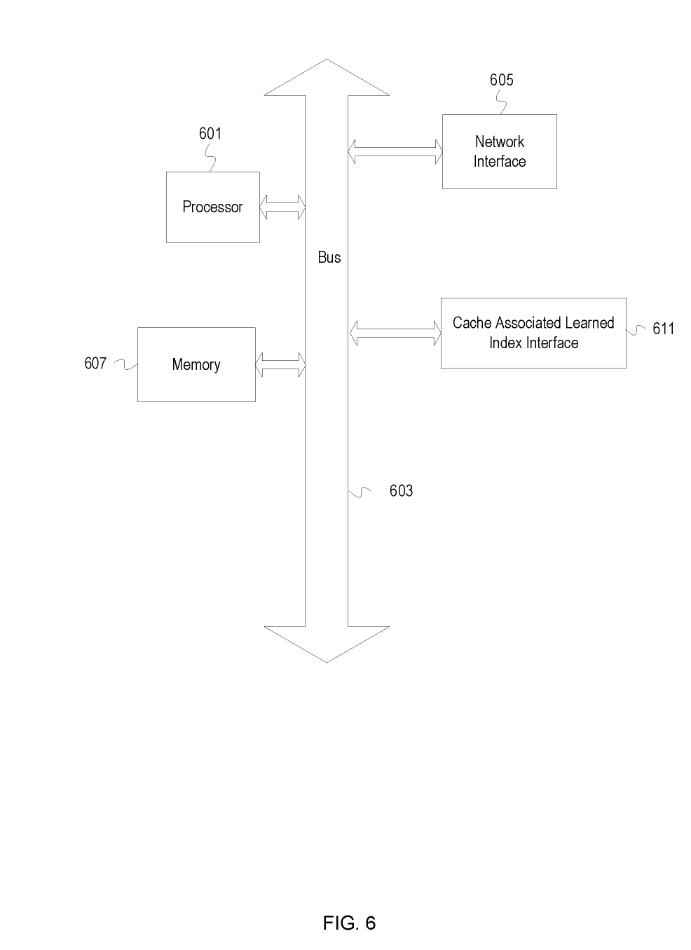

FIG. 6 depicts an example computer system with a cache associated learned index interface. The computer system includes a processor unit 601 (possibly including multiple processors, multiple cores, multiple nodes, and/or implementing multi-threading, etc.). The computer system includes memory 607. The memory 607 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 603 (e.g., PCI, ISA, PCI-Express, HyperTransport® bus, InfiniBand® bus, NuBus, etc.) and a network interface 605 (e.g., a Fiber Channel interface, an Ethernet interface, an internet small computer system interface, SONET interface, wireless interface, etc.). The system also includes a cache associated learned index interface 611. The cache associated learned index interface 611 provides data retrieval using a learned index which allows for insertions of new data without requiring retraining. Any one of the previously described functionalities may be partially (or entirely) implemented in hardware and/or on the processor unit 601. For example, the functionality may be implemented with an application specific integrated circuit, in logic implemented in the processor unit 601, in a co-processor on a peripheral device or card, etc. Further, realizations may include fewer or additional components not illustrated in FIG. 6 (e.g., video cards, audio cards, additional network interfaces, peripheral devices, etc.). The processor unit 601 and the network interface 605 are coupled to the bus 603. Although illustrated as being coupled to the bus 603, the memory 607 may be coupled to the processor unit 601.

While the aspects of the disclosure are described with reference to various implementations and exploitations, it will be understood that these aspects are illustrative and that the scope of the claims is not limited to them. In general, techniques for providing a learned index which can tolerate insertions as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
based on receipt of a first key to be inserted in a learned index structure,
associating a first cache with a first model of the learned index structure; and
inserting the first key in an entry of the first cache; and
based on receipt of a read request corresponding to the first key,
determining that the first key is not located within the learned index structure; and
based on determining that the first key is not located within the learned index structure,
searching caches associated with models of the learned index structure; and
identifying the first key in the first cache and returning data for the read request.

2. The method of claim 1 further comprising:
based on receipt of a second key to be inserted in the learned index structure,
traversing the caches associated with the models of the learned index structure to identify an available cache entry; and
based on determining that there is not an available cache entry, retraining the learned index structure.

3. The method of claim 2 further comprising:
prior to retraining the learned index structure,
flushing keys from the caches associated with the models of the learned index structure; and
performing insertions for the flushed keys.

4. The method of claim 2, wherein traversing the caches associated with the models of the learned index structure to identify an available cache entry comprises:
inputting the second key into the learned index structure;
determining which of the models of the learned index structure were activated based on inputting the second key; and
determining whether any of the models of the learned index structure which were activated based on inputting the second key are associated with an available cache entry.

5. The method of claim 4 further comprising, based on determining that none of the models of the learned index structure which were activated based on inputting the second key are associated with an available cache entry, determining that the caches associated with the models of the learned index structure are full.

6. The method of claim 1, wherein associating a first cache with a first model of the learned index structure is in response to determining that the first model is not already associated with a cache.

7. The method of claim 1, wherein identifying the first key in the first cache and returning the data for the read request comprising retrieving a pointer associated with the first key which points to the data for the read request.

8. The method of claim 1 further comprising:
based on receipt of a third key to be inserted in the learned index structure,
determining that the third key may be appended to keys already indexed the learned index structure;
appending the third key to the already indexed keys; and
adding a model to the learned index structure which points to a location comprising the third key.

9. The method of claim 1, wherein inserting the first key in an entry of the first cache comprises tagging the first key with a sequential identifier, wherein the sequential identifier indicates an order the first key was received relative to other keys in the caches associated with the models of the learned index structure.

10. One or more non-transitory machine-readable media comprising program code, the program code to:
based on receipt of a first key to be inserted in a learned index structure,
associate a first cache with a first model of the learned index structure; and
insert the first key in an entry of the first cache; and
based on receipt of a read request corresponding to the first key,
determine that the first key is not located within the learned index structure; and
based on a determination that the first key is not located within the learned index structure,
search caches associated with models of the learned index structure; and
identify the first key in the first cache and return data for the read request.

11. The machine-readable media of claim 10 further comprising program code to:
based on receipt of a second key to be inserted in the learned index structure,
traverse the caches associated with the models of the learned index structure to identify an available cache entry; and
based on a determination that there is not an available cache entry, retrain the learned index structure.

12. An apparatus comprising:
a processor; and
a machine-readable medium having program code executable by the processor to cause the apparatus to,
based on receipt of a first key to be inserted in a learned index structure,
associate a first cache with a first model of the learned index structure; and
insert the first key in an entry of the first cache; and
based on receipt of a read request corresponding to the first key,
determine that the first key is not located within the learned index structure; and
based on a determination that the first key is not located within the learned index structure,
search caches associated with models of the learned index structure; and
identify the first key in the first cache and return data for the read request.

13. The apparatus of claim 12 further comprising program code to:
based on receipt of a second key to be inserted in the learned index structure,
traverse the caches associated with the models of the learned index structure to identify an available cache entry; and
based on a determination that there is not an available cache entry, retrain the learned index structure.

14. The apparatus of claim 13 further comprising program code to:
prior to retraining the learned index structure,
flush keys from the caches associated with the models of the learned index structure; and
perform insertions for the flushed keys.

15. The apparatus of claim 13, wherein the program code to traverse the caches associated with the models of the learned index structure to identify an available cache entry comprises program code to:
inputting the second key into the learned index structure;
determine which of the models of the learned index structure were activated based on inputting the second key; and
determine whether any of the models of the learned index structure which were activated based on inputting the second key are associated with an available cache entry.

16. The apparatus of claim 15 further comprising program code to, based on determining that none of the models of the learned index structure which were activated based on inputting the second key are associated with an available cache entry, determine that the caches associated with the models of the learned index structure are full.

17. The apparatus of claim 12, wherein the program code to associate a first cache with a first model of the learned index structure is in response to a determination that the first model is not already associated with a cache.

18. The apparatus of claim 12, wherein the program code to identify the first key in the first cache and return the data for the read request comprises program code to retrieve a pointer associated with the first key which points to the data for the read request.

19. The apparatus of claim 12 further comprising program code to:
based on receipt of a third key to be inserted in the learned index structure,
determining that the third key may be appended to keys already indexed the learned index structure;
appending the third key to the already indexed keys; and
adding a model to the learned index structure which points to a location comprising the third key.

20. The apparatus of claim 12, wherein the program code to insert the first key in an entry of the first cache comprises program code to tag the first key with a sequential identifier, wherein the sequential identifier indicates an order the first key was received relative to other keys in the caches associated with the models of the learned index structure.
